(19) United States
(12) Patent Application Publication
(10) Pub. No.: US 2020/0072293 A1
(43) Pub. Date: Mar. 5, 2020

(54) POWER TRANSMISSION DEVICE

(71) Applicant: EXEDY Corporation, Neyagawa-shi, Osaka (JP)

(72) Inventors: Yasunori DOMAN, Neyagawa-shi, Osaka (JP); Takeshi SENOUE, Neyagawa-shi, Osaka (JP); Yoshinari YOSHIMURA, Neyagawa-shi, Osaka (JP)

(21) Appl. No.: 16/466,450

(22) PCT Filed: Jan. 15, 2018
(86) PCT No.: PCT/JP2018/000753

§ 371 Date: Jun. 4, 2019

(30) Foreign Application Priority Data
Feb. 3, 2017 (JP) 2017-018714

(51) Int. Cl. F16D 3/12; F16F 15/134

(52) U.S. Cl. CPC F16D 3/12; F16F 15/30; F16F 2230/007; F16F 15/13469

(57) ABSTRACT

A power transmission device includes an input-side rotary part to which a torque is inputted from an engine, an output-side rotary part, and a damper part. The output-side rotary part includes a first rotor and a second rotor. The first rotor is configured to be rotatable relative to the input-side rotary part. The first rotor is configured to be rotatable unitarily with the input-side rotary part at greater than or equal to a predetermined relative rotational angle. The second rotor is configured to be rotatable unitarily with the first rotor. The second rotor is configured to be rotatable relative to the first rotor at greater than or equal to the predetermined relative rotational angle. The damper part is configured to elastically couple the input-side rotary part and the output-side rotary part.

### CROSS-REFERENCE TO RELATED APPLICATIONS

This application is the U.S. National Phase of PCT International Application No. PCT/JP2018/000753, filed on Jan. 15, 2018. That application claims priority to Japanese Patent Application No. 2017-018714, filed Feb. 3, 2017. The contents of both applications are incorporated by reference herein in their entirety.

### BACKGROUND

### Technical Field

The present disclosure relates to a power transmission device.

### Background Art

A power transmission device, for instance, a flywheel assembly includes a first flywheel (input-side rotary part), a second flywheel (output-side rotary part) and a damper mechanism (damper part). A torque from an engine is inputted to the first flywheel. The second flywheel is configured to be rotatable relative to the first flywheel. The damper mechanism transmits the torque from the first flywheel to the second flywheel. See Japan Laid-open Patent Application Publication No. 2013-167312.

### BRIEF SUMMARY

In a well-known flywheel assembly, when the frequency of a vibration system of the flywheel assembly approaches a resonance range in actuation of the flywheel assembly, a fluctuation component of a torsion angle of the second flywheel with respect to the first flywheel increases in magnitude. Here, when increase in magnitude of the fluctuation component of the torsion angle occurs as described above in a condition that an average component of the torsion angle of the second flywheel with respect to the first flywheel is large in magnitude, it is concerned that vibration cannot be sufficiently reduced in the flywheel assembly.

In the well-known flywheel assembly, when the torsion angle of the second flywheel with respect to the first flywheel reaches a predetermined angle, the second flywheel is restricted from rotating with respect to the first flywheel through a stopper structure.

For example, when composed of spring seats disposed on the both ends of a torsion spring, the stopper structure is actuated by contact between the spring seats.

On the other hand, when composed of a plurality of torsion springs coupling the first flywheel and the second flywheel to each other, the stopper structure is actuated by full compression of the respective torsion springs.

When the stopper structure is actuated, an impact force is inputted to the first flywheel from the second flywheel. Because of this, the first flywheel is required to be designed to be resistible against the impact force. For example, in such a condition that the frequency of the vibration system of the flywheel assembly approaches the resonance range, the first flywheel is also required to be designed to be resistible against the impact force. Because of this, in the well-known flywheel assembly, it is concerned that the first flywheel is inevitably increased in component dimension. In other words, it is concerned that the power transmission device is inevitably enlarged.

The present disclosure has been produced in view of the aforementioned drawback. It is an object of the present disclosure to make a power transmission device compact.

(1) A power transmission device according to an aspect of the present disclosure includes an input-side rotary part, an output-side rotary part and a damper part. The input-side rotary part is a part to which a torque is inputted from an engine. The output-side rotary part includes a first rotor and a second rotor. The first rotor is configured to be rotatable relative to the input-side rotary part, and is configured to be rotatable unitarily with the input-side rotary part at greater than or equal to a predetermined relative rotational angle. The second rotor is configured to be rotatable unitarily with the first rotor, and is configured to be rotatable relative to the first rotor at greater than or equal to the predetermined relative rotational angle. The damper part elastically couples the input-side rotary part and the output-side rotary part.

In the present power transmission device, when the relative rotational angle of the first rotor to the input-side rotary part reaches the predetermined relative rotational angle while the output-side rotary part (the first rotor and the second rotor) is being rotated relative to the input-side rotary part, the first rotor is rotated unitarily with the input-side rotary part whereas the second rotor is rotated relative to the first rotor.

In other words, when the aforementioned relative rotational angle is greater than or equal to the predetermined relative rotational angle, only the first rotor is rotated unitarily with the input-side rotary part, whereas the second rotor is rotated relative to the first rotor. Thus, a force inputted to the input-side rotary part from the output-side rotary part can be reduced by causing the second rotor to be rotated relative to the first rotor. Because of this, the input-side rotary part can be made compact. In other words, the power transmission device can be made compact.

(2) According to another aspect of the present disclosure, the power transmission device preferably further includes a stopper structure. The stopper structure restricts the input-side rotary part and the first rotor from rotating relative to each other at greater than or equal to the predetermined relative rotational angle.

In this case, when the aforementioned relative rotational angle reaches the predetermined relative rotational angle, the stopper structure is actuated whereby the first rotor can be preferably and suitably rotated unitarily with the input-side rotary part.

(3) According to yet another aspect of the present disclosure, the power transmission device preferably further includes a holding part. The holding part holds the first rotor and the second rotor so as to make the first rotor and the second rotor rotatable unitarily with each other at less than the predetermined relative rotational angle.

In this case, at less than the predetermined relative rotational angle, the first rotor and the second rotor can be preferably and suitably rotated unitarily with each other by the holding part. Because of this, at less than the predetermined relative rotational angle, the output-side rotary part (the first rotor and the second rotor) can be stably rotated relative to the input-side rotary part.

(4) According to still another aspect of the present disclosure, preferably in the power transmission device, the holding part releases holding of the first rotor and the second rotor at greater than or equal to the predetermined relative rotational angle.

In this case, at greater than or equal to the predetermined relative rotational angle, the second rotor can be preferably and suitably rotated relative to the first rotor. Because of this, at greater than or equal to the predetermined relative rotational angle, the force inputted to the input-side rotary part from the output-side rotary part can be preferably and suitably reduced.

(5) According to further yet another aspect of the present disclosure, preferably in the power transmission device, the second rotor is provided on the first rotor through the holding part. With this configuration, the second rotor can be preferably and suitably rotated unitarily with the first rotor at less than the predetermined relative rotational angle, and the second rotor can be preferably and suitably rotated relative to the first rotor at greater than or equal to the predetermined relative rotational angle.

(6) According to still yet another aspect of the present disclosure, preferably in the power transmission device, the second rotor is rotated relative to the first rotor in a rotational direction of the first rotor at greater than or equal to the predetermined relative rotational angle. With this configuration, the second rotor can be smoothly rotated relative to the first rotor.

(7) According to further still yet another aspect of the present disclosure, preferably in the power transmission device, the damper part elastically couples the input-side rotary part and the first rotor. With this configuration, a torque can be preferably and suitably transmitted from the input-side rotary part to the first rotor, and simultaneously, the second rotor can be preferably and suitably rotated relative to the first rotor.

According to the present disclosure, the power transmission device can be made compact.

### BRIEF DESCRIPTION OF THE DRAWINGS

FIG. 1 is a cross-sectional diagram schematically showing a flywheel assembly according to a first embodiment.

FIG. 2A is a diagram for explaining action of a stopper structure of the flywheel assembly.

FIG. 2B is a diagram for explaining the action of the stopper structure of the flywheel assembly.

FIG. 3 is a cross-sectional diagram schematically showing a damper device according to a second embodiment.

FIG. 4 is a cross-sectional diagram schematically showing a damper device according to a modification of the second embodiment.

### DETAILED DESCRIPTION OF EMBODIMENTS

### First Embodiment

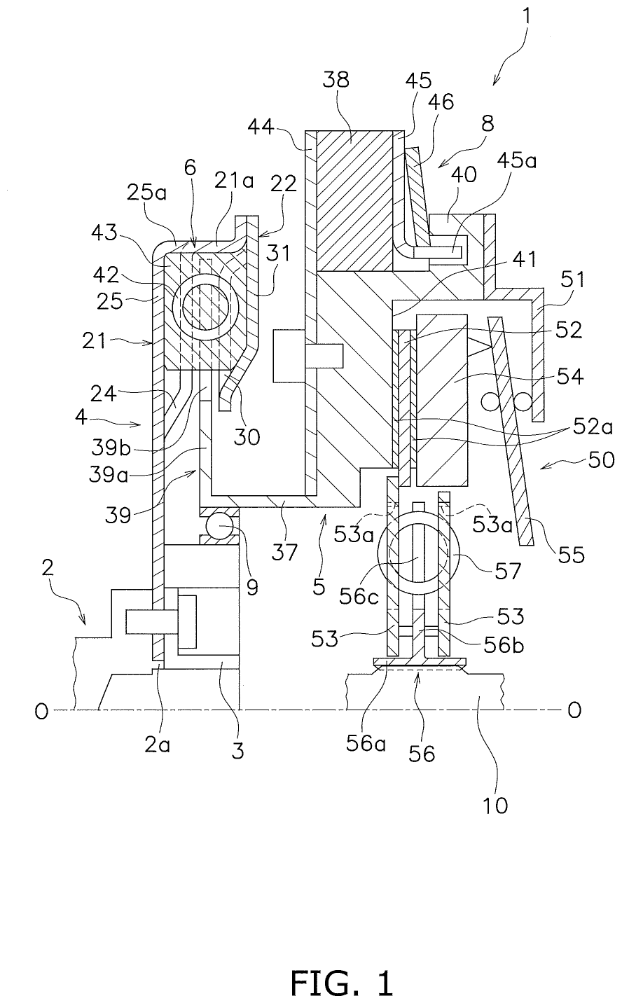

FIG. 1 is a cross-sectional diagram schematically expressing a flywheel assembly 1 according to an embodiment of the present disclosure. The flywheel assembly 1 transmits a torque, transmitted thereto from a crankshaft 2, to a transmission through a clutch device 50. The flywheel assembly 1 includes a first flywheel 4 (exemplary input-side rotary part), a second flywheel 5 (exemplary output-side rotary part), a damper structure 6 (exemplary damper part), a stopper structure 7 and a holding structure 8 (exemplary holding part). It should be noted that in FIG. 1, an engine is disposed on the left side whereas the transmission is disposed on the right side.

[First Flywheel]

A torque is inputted to the first flywheel 4 from the engine. Detailedly, the torque is inputted to the first flywheel 4 from the engine-side crankshaft 2. As shown in FIG. 1, the first flywheel 4 is fixed to the crankshaft 2 by fixation means such as at least one fixation bolt.

The first flywheel 4 includes a first plate 21 and a second plate 22. The first plate 21 includes a first plate body 24 and a plurality of first damper accommodation parts 25.

The first plate body 24 has a substantially annular shape. The first plate body 24 makes contact at the inner peripheral part thereof with the outer peripheral surface of a protruding portion 2a for positioning use in the crankshaft 2. Because of this, the first plate body 24 is radially positioned by the crankshaft 2.

The respective plural first damper accommodation parts 25 are provided in the outer peripheral part of the first plate 21. Detailedly, the respective plural first damper accommodation parts 25 are provided in the outer peripheral part of the first plate 21, while being aligned about a rotational axis O at predetermined intervals in a circumferential direction.

The second plate 22 includes a second plate body 30 and a plurality of damper accommodation parts 31.

The second plate body 30 has a substantially annular shape. The second plate body 30 is fixed at the outer peripheral part thereof to an outer tubular portion 21a provided in the outer peripheral part of the first plate 21 and outer peripheral portions 25a of the first damper accommodation parts 25. The second plate body 30 is disposed in axial opposition to the first plate body 24.

The plural second damper accommodation parts 31 are disposed in axial opposition to the plural first damper accommodation parts 25, respectively. Detailedly, the plural second damper accommodation parts 31 are disposed in axial opposition to the plural first damper accommodation parts 25, respectively, while being aligned at predetermined intervals in the circumferential direction.

The first damper accommodation parts 25 and the second damper accommodation parts 31 are herein formed such that the axial width therebetween is wider than that between the first plate body 24 and the second plate body 30. The damper structure 6 is accommodated in accommodation spaces formed by the first damper accommodation parts 25 and the second damper accommodation parts 31.

[Second Flywheel]

The second flywheel 5 includes a second flywheel body 37 (exemplary first rotor) and an inertia part 38 (exemplary second rotor).

The second flywheel body 37 is configured to be rotatable relative to the first flywheel 4. The second flywheel body 37 is rotatably supported by a center boss 3, fixed to the crankshaft 2, through a bearing 9.

The second flywheel body 37 is provided with an engaging part 39, a plurality of recesses 40 and a contact surface 41. The engaging part 39 includes an annular portion 39a and a plurality of first transmission portions 39b. The annular portion 39a is disposed radially inside the damper structure 6.

The respective plural first transmission portions 39b are portions that receive a torque from the damper structure 6 after the torque is transmitted to the damper structure 6 from the first flywheel 4. The respective plural first transmission portions 39b are provided on the outer periphery of the annular portion 39a. Detailedly, the respective plural first transmission portions 39b are provided on the outer periphery of the annular portion 39a, while being aligned at predetermined intervals in the circumferential direction.

Additionally, the respective plural first transmission portions 39b extend radially outward from the annular portion 39a, and are disposed in the aforementioned accommodation spaces. Additionally, each of the plural first transmission portions 39b is disposed between circumferentially adjacent two of spring seats 43 in the damper structure 6.

The respective plural recesses 40 are provided in the outer peripheral part of the second flywheel body 37, while being aligned at intervals in the circumferential direction. The respective plural recesses 40 are opened toward the inertia part 38.

The contact surface 41 is a surface with which one of friction members 52a of a cushioning plate 52 in the clutch device 50 (to be described) makes contact. Detailedly, when the one friction member 52a of the cushioning plate 52 makes contact with the contact surface 41, the torque is transmitted from the flywheel assembly 1 to the clutch device 50. On the other hand, when the one friction member 52a of the cushioning plate 52 separates from the contact surface 41, transmission of the torque from the flywheel assembly 1 to the clutch device 50 is disabled.

The inertia part 38 is configured to be rotatable unitarily with the second flywheel body 37. Furthermore, the inertia part 38 is configured to be rotatable relative to the second flywheel body 37 when an angle α of relative rotation of the second flywheel body 37 to the first flywheel 4 becomes greater than or equal to a predetermined angle α1 of relative rotation.

For example, the inertia part 38 has a substantially annular shape. The inertia part 38 is disposed on the outer periphery of the second flywheel body 37. When the relative rotational angle α of the second flywheel body 37 with respect to the first flywheel 4 is less than the predetermined relative rotational angle α1, the inertia part 38 is held by the holding structure 8.

On the other hand, when the relative rotational angle α of the second flywheel body 37 with respect to the first flywheel 4 is greater than or equal to the predetermined relative rotational angle α1, the inertia part 38 is released from being held by the holding structure 8 and is rotated relative to the second flywheel body 37.

Detailedly, when the relative rotational angle α of the second flywheel body 37 with respect to the first flywheel 4 reaches the predetermined relative rotational angle α1, the stopper structure 7 is actuated. At this time, the inertia part 38 is released from being held by the holding structure 8 and is rotated in the same rotational direction as the second flywheel body 37.

[Damper Structure]

The damper structure 6 elastically couples the first flywheel 4 and the second flywheel 5, and transmits a torque from the first flywheel 4 to the second flywheel 5. As shown in FIG. 1, the damper structure 6 includes a plurality of first torsion springs 42 and the plurality of spring seats 43.

The plural first torsion springs 42 are disposed in the aforementioned accommodation spaces, respectively. The respective plural spring seats 43 are disposed on the both ends of the respective plural first torsion springs 42. Additionally, the spring seats 43, disposed on the both ends of the respective first torsion springs 42, are also disposed in the aforementioned accommodation spaces, respectively.

The first flywheel 4 makes contact at the first plate body 24 of the first plate 21 and the second plate body 30 of the second plate 22 with each one-side spring seat 43. On the other hand, the second flywheel 5 makes contact at each first transmission portion 39b with each other-side spring seat 43.

In this state, when the first flywheel 4 and the second flywheel 5 are rotated relative to each other, the torque inputted to the first flywheel 4 (the first plate body 24 and the second plate body 30) is transmitted to each first torsion spring 42 through each one-side spring seat 43. Then, the torque transmitted to each first torsion spring 42 is transmitted to the second flywheel 5 (each first transmission portion 39b) through each other-side spring seat 43.

[Stopper Structure]

The stopper structure 7 restricts the first flywheel 4 and the second flywheel body 37 from rotating relative to each other when the relative rotational angle α of the second flywheel body 37 with respect to the first flywheel 4 is greater than or equal to the predetermined relative rotational angle α1. In other words, the stopper structure 7 is actuated at the aforementioned predetermined relative rotational angle α1 so as to restrict the first flywheel 4 and the second flywheel body 37 from rotating relative to each other.

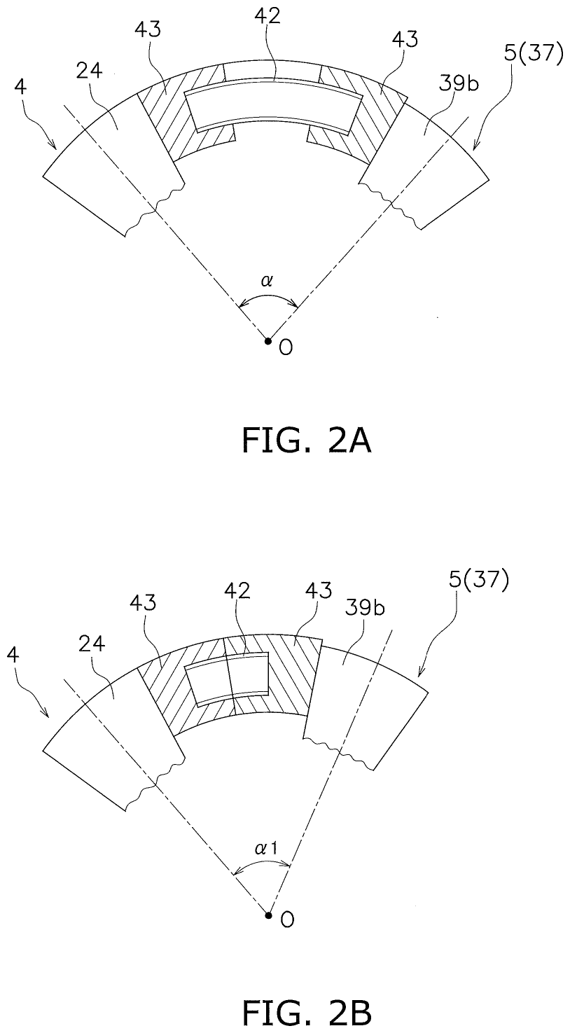

As shown in FIGS. 1 and 2, the stopper structure 7 is composed of a plurality of pairs of spring seats 43 disposed on the both ends of the respective plural first torsion springs 42. Each pair of spring seats 43 makes contact with each other when the relative rotational angle α of the second flywheel body 37 with respect to the first flywheel 4 reaches the predetermined relative rotational angle α1. Because of this, each first torsion spring 42, disposed between each pair of spring seats 43, is made incompressible.

Thus, the state that each pair of spring seats 43 makes contact with each other while each first torsion spring 42 is incompressible is a state that the stopper structure 7 is being actuated. When this state is made, the inertia part 38 is released from being held by the holding structure 8, and as described above, is rotated in the same rotational direction as the second flywheel body 37.

[Holding Structure]

The holding structure 8 holds the second flywheel body 37 and the inertia part 38 so as to make the both unitarily rotatable. On the other hand, when the relative rotational angle α of the second flywheel body 37 with respect to the first flywheel 4 is greater than or equal to the predetermined relative rotational angle α1, the holding structure 8 releases holding of the second flywheel body 37 and the inertia part 38.

As shown in FIG. 1, the holding structure 8 is composed of a first holding plate 44, a second holding plate 45, a cone spring 46, and the plural recesses 40 of the aforementioned second flywheel body 37.

The first holding plate 44 is configured to be unitarily rotatable with the second flywheel body 37. For example, the first holding plate 44 herein has a substantially annular shape. The first holding plate 44 is fixed to the second flywheel body 37 by fixation means such as at least one bolt.

The second holding plate 45 is configured to be unitarily rotatable with the second flywheel body 37. The second holding plate 45 is disposed at an interval from the first holding plate 44 in the axial direction. For example, the second holding plate 45 is herein an annular member having an L-shaped cross section. The second holding plate 45 is provided with a plurality of protrusions 45a. The respective plural protrusions 45a are provided in the inner peripheral part of the second holding plate 45, and protrude in the axial direction.

The respective plural protrusions 45a are provided at intervals in the circumferential direction. The plural protrusions 45a are separately disposed in the plural recesses 40 of the second flywheel body 37, respectively. Because of this, the second holding plate 45 is made unitarily rotatable with the second flywheel body 37 and is also made movable in the axial direction.

The cone spring 46 is disposed axially between the second holding plate 45 and a part provided with the plural recesses 40 in the second flywheel body 37. Detailedly, the cone spring 46 is disposed axially between the second holding plate 45 and the opening-side end surfaces of the plural recesses 40. In this state, the cone spring 46 makes contact at the inner peripheral part thereof with the end surfaces of the plural recesses 40, while making contact at the outer peripheral part thereof with the second holding plate 45.

Because of this, the inertia part 38 is interposed and held between the first holding plate 44 and the second holding plate 45 through the cone spring 46. Detailedly, when the relative rotational angle α of the second flywheel body 37 with respect to the first flywheel 4 is less than the predetermined relative rotational angle α1, the inertia part 38 is interposed and held between the first holding plate 44 and the second holding plate 45 through the cone spring 46. Put differently, in this case, the inertia part 38 is unitarily rotated with the second flywheel body 37 through the holding structure 8.

On the other hand, when the relative rotational angle α of the second flywheel body 37 with respect to the first flywheel 4 is greater than or equal to the predetermined relative rotational angle α1, in other words, when the stopper structure 7 is actuated, the inertia part 38 is released from being interposed and held by the holding structure 8.

Detailedly, when the relative rotational angle α of the second flywheel body 37 with respect to the first flywheel 4 becomes greater than or equal to the predetermined relative rotational angle α1, a rotation-directional inertia force acting on the inertia part 38 becomes greater than a holding force (e.g., a friction force) applied between the holding structure 8 (the first holding plate 44 and the second holding plate 45) and the inertia part 38 as a result of the actuation of the stopper structure 7. Accordingly, the inertia part 38 slides against the first holding plate 44 and the second holding plate 45 in the rotational direction of the second flywheel body 37. Because of this, in this case, the inertia part 38 is rotated relative to the second flywheel body 37.

[Clutch Device]

The clutch device 50 transmits a torque from the flywheel assembly 1 to a transmission-side member 10, and also, disables transmission of the torque from the flywheel assembly 1 to the transmission-side member 10.

As shown in FIG. 1, the clutch device 50 includes a clutch cover 51, the cushioning plate 52, a pair of plates 53 for clutch use, a pressure plate 54, a diaphragm spring 55, an output hub 56, and a plurality of second torsion springs 57.

The clutch cover 51 is attached to the flywheel assembly 1. The clutch cover 51 is herein fixed to the second flywheel body 37 of the flywheel assembly 1 by fixation means such as at least one bolt (not shown in the drawing).

A torque is inputted to the cushioning plate 52 from the flywheel assembly 1. The cushioning plate 52 has a substantially annular shape. The cushioning plate 52 is disposed in opposition to the second flywheel body 37. Detailedly, the cushioning plate 52 is disposed in opposition to the contact surface 41 of the second flywheel body 37. The friction members 52a are attached to the both surfaces of the cushioning plate 52. The cushioning plate 52 is fixed to one of the pair of plates 53 for clutch use, while being unitarily rotatable therewith.

The pair of plates 53 for clutch use, each having a substantially annular shape, is disposed in axial opposition to each other. Detailedly, the pair of plates 53 for clutch use is disposed at an interval from each other in the axial direction. The pair of plates 53 for clutch use is fixed to each other by fixation means such as at least one rivet (not shown in the drawing).

The pressure plate 54 presses the cushioning plate 52 to which the friction members 52a are attached. The pressure plate 54 has a substantially annular shape. The pressure plate 54 is disposed axially between the cushioning plate 52 and the diaphragm spring 55. The pressure plate 54 is urged by the diaphragm spring 55 toward the contact surface 41 of the second flywheel body 37.

The diaphragm spring 55 presses the pressure plate 54. The outer peripheral part of the diaphragm spring 55 is disposed axially between the pressure plate 54 and the clutch cover 51. The inner peripheral part of the diaphragm spring 55 is pressed by a pressure applying member (not shown in the drawing). The middle part of the diaphragm spring 55 is supported by the clutch cover 51.

The output hub 56 is attached to the transmission-side member 10, while being unitarily rotatable therewith. For example, a boss portion 56a of the output hub 56 is attached to the transmission-side member 10 by spline coupling, while being unitarily rotatable therewith. A flange portion 56b of the output hub 56 is disposed axially between the pair of plates 53 for clutch use.

The flange portion 56b is provided with a plurality of second transmission portions 56c in the outer peripheral part thereof. The plural second transmission portions 56c are separately engaged with the plural second torsion springs 57, respectively. The respective plural second transmission portions 56c protrude radially outward from the flange portion 56b, while being aligned at intervals in the circumferential direction.

The plural second torsion springs 57 elastically couple the pair of plates 53 for clutch use and the output hub 56. Detailedly, each of the plural second torsion springs 57 is disposed between circumferentially adjacent two of the second transmission portions 56c. Additionally, the plural second torsion springs 57 are disposed in pairs of window portions 53a of the pair of plates 53 for clutch use, respectively.

In the aforementioned clutch device 50, when the pressure plate 54 is pressed by the diaphragm spring 55, the aforementioned one of the friction members 52a on the cushioning plate 52 makes contact with the contact surface 41 of the second flywheel body 37. Accordingly, a torque is transmitted from the flywheel assembly 1 to the clutch device 50. This is an on state of the clutch device 50.

On the other hand, when a pressing force applied to the diaphragm spring 55 is released, the aforementioned one of the friction members 52a on the cushioning plate 52 separates from the contact surface 41. Accordingly, transmission of the torque from the flywheel assembly 1 to the clutch device 50 is disabled. This is an off state of the clutch device 50.

[Action of Flywheel Assembly]

In the on state of the clutch device 50, when the torque of the engine is inputted to the flywheel assembly 1, this torque is transmitted from the first flywheel 4 to the second flywheel 5 through the damper structure 6.

Here, when the relative rotational angle α of the second flywheel body 37 with respect to the first flywheel 4 is less than the predetermined relative rotational angle α1, the second flywheel body 37 and the inertia part 38 are rotated relative to the first flywheel 4 while being held by the holding structure 8. On the other hand, when the relative rotational angle α of the second flywheel body 37 with respect to the first flywheel 4 is greater than or equal to the predetermined relative rotational angle α1, the stopper structure 7 is actuated. Accordingly, the inertia part 38 is released from being interposed and held by the holding structure 8, and is thereby rotated relative to the second flywheel body 37.

In the aforementioned flywheel assembly 1, when the relative rotational angle α of the second flywheel body 37 with respect to the first flywheel 4 reaches the predetermined relative rotational angle α1 (when the stopper structure 7 is actuated), the second flywheel body 37 is rotated unitarily with the first flywheel 4, whereas the inertia part 38 is rotated relative to the second flywheel body 37.

Because of this, when the relative rotational angle α of the second flywheel body 37 with respect to the first flywheel 4 reaches the predetermined relative rotational angle α1 (when the stopper structure 7 is actuated), the inertia part 38 is released from the second flywheel body 37 whereby a force inputted to the first flywheel 4 from the second flywheel 5 can be reduced. Because of this, the first flywheel 4 can be made compact. In other words, the flywheel assembly 1 can be made compact.

### Second Embodiment

The aforementioned first embodiment has exemplified the configuration of the flywheel assembly 1 that when the relative rotational angle α of the second flywheel body 37 with respect to the first flywheel 4 reaches the predetermined relative rotational angle α1, the second flywheel body 37 is rotated unitarily with the first flywheel 4, whereas the inertia part 38 is rotated relative to the second flywheel body 37.

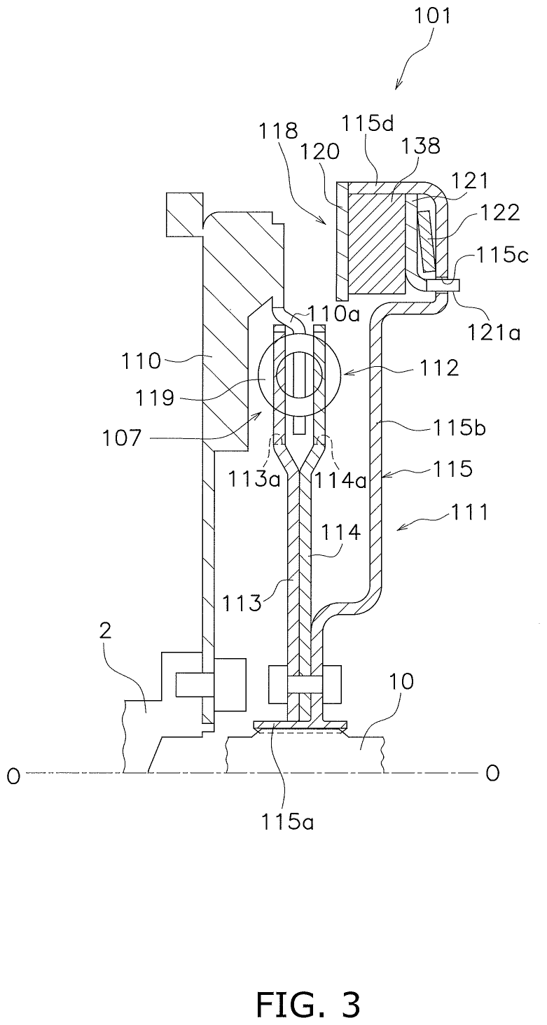

Instead of this configuration, the present disclosure can be applied to a damper device 101 (exemplary power transmission device) shown in FIG. 3. Configurations of the present disclosure, characterized in realizing the present disclosure, will be herein explained in detail, but the other configurations will be briefly explained.

The damper device 101 transmits a torque, transmitted thereto from the engine-side crankshaft 2, to the transmission. The damper device 101 includes an input-side rotary part 110, an output-side rotary part 111, a damper part 112 and a holding structure 118 (exemplary holding part).

The torque, transmitted from the engine-side crankshaft 2, is inputted to the input-side rotary part 110. The input-side rotary part 110 is fixed to the crankshaft 2 by fixation means such as at least one fixation bolt. The input-side rotary part 110 is provided with a plurality of third transmission portions 110a separately engaged with the damper part 112.

The output-side rotary part 111 is configured to be rotatable relative to the input-side rotary part 110. The output-side rotary part 111 includes first to third output-side plates 113, 114 and 115 (exemplary first rotor) and an inertia part 138 (exemplary second rotor).

The first to third output-side plates 113, 114 and 115 are configured to be rotatable relative to the input-side rotary part 110.

The first output-side plate 113 and the second output-side plate 114 are disposed in axial opposition to each other. The third output-side plate 115 includes a boss portion 115a and a plate body 115b. The boss portion 115a is attached to the transmission-side member 10 by coupling means such as spline coupling, while being unitarily rotatable therewith. The plate body 115b extends radially outward from the outer peripheral surface of the boss portion 115a. The plate body 115b is provided with a plurality of holes 115c in the outer peripheral part thereof. The plate body 115b is provided with an outer tubular portion 115d as the outer peripheral end thereof. The first output-side plate 113 and the second output-side plate 114 are fixed to the inner peripheral part of the plate body 115b by fixation means such as at least one bolt.

The inertia part 138 is configured to be unitarily rotatable with the third output-side plate 115 through the holding structure 118. Additionally, when the relative rotational angle α of the first to third output-side plates 113, 114 and 115 with respect to the input-side rotary part 110 is greater than or equal to the predetermined relative rotational angle α1, the inertia part 138 is configured to be rotatable relative to the first to third output-side plates 113, 114 and 115.

Detailedly, when the relative rotational angle α of the first to third output-side plates 113, 114 and 115 with respect to the input-side rotary part 110 is greater than or equal to the predetermined relative rotational angle α1, the inertia part 138 is released from being held by the holding structure 118, and is thereby rotated relative to the first to third output-side plates 113, 114 and 115 in the same rotational direction as the first to third output-side plates 113, 114 and 115.

The damper part 112 elastically couples the input-side rotary part 110 and the output-side rotary part 111. The damper part 112 includes a plurality of third torsion springs 119. Each of the plural third torsion springs 119 is disposed between circumferentially adjacent two of the third transmission portions 110a in the input-side rotary part 110. Additionally, the plural third torsion springs 119 are disposed in a plurality of pairs of window portions 113a and 114a of the output-side rotary part 111 (the first and second output-side plates 113 and 114), respectively.

When the relative rotational angle α of the first to third output-side plates 113, 114 and 115 with respect to the input-side rotary part 110 is greater than or equal to the predetermined relative rotational angle α1, a stopper structure 107 restricts the input-side rotary part 110 and the first to third output-side plates 113, 114 and 115 from rotating relative to each other. In other words, the stopper structure 107 is actuated at the aforementioned predetermined relative rotational angle α1 so as to restrict the input-side rotary part 110 and the first to third output-side plates 113, 114 and 115 from rotating relative to each other.

The stopper structure 107 is composed of the respective plural third torsion springs 119. Each third torsion spring 119 is fully compressed when the relative rotational angle α of the first to third output-side plates 113, 114 and 115 with respect to the input-side rotary part 110 reaches the predetermined relative rotational angle α1. Because of this, each third torsion spring 119 is made incompressible.

Thus, the state that each third torsion spring 119 is fully compressed is a state that the stopper structure 107 is being actuated. When this state is made, the inertia part 138 is released from being held by the holding structure 118, and as described above, is rotated relative to the first to third output-side plates 113, 114 and 115 in the same rotational direction as the first to third output-side plates 113, 114 and 115.

The holding structure 118 is composed of a first holding plate 120, a second holding plate 121, a cone spring 122, and the aforementioned plural holes 115c of the third output-side plate 115.

The first holding plate 120 is fixed to the outer tubular portion 115d of the third output-side plate 115 by fixation means such as welding. The inertia part 138 is disposed in a space enclosed by the first holding plate 120, the outer tubular portion 115d of the third output-side plate 115 and the outer peripheral part of the third output-side plate 115.

The second holding plate 121 is configured to be unitarily rotatable with the third output-side plate 115. The second holding plate 121 is disposed in axial opposition to the first holding plate 120. The second holding plate 121 is provided with a plurality of protruding portions 121a. The plural protruding portions 121a are separately disposed in the plural holes 115c of the third output-side plate 115, respectively. The cone spring 122 is disposed axially between the second holding plate 121 and the outer peripheral part of the third output-side plate 115 (the plate body 115b).

Even in the configuration of the damper device 101 herein described, when the relative rotational angle α of the first to third output-side plates 113, 114 and 115 with respect to the input-side rotary part 110 is greater than or equal to the predetermined relative rotational angle α1 (when the stopper structure 107 is actuated), the inertia part 138 is released from being held by the holding structure 118, and is thereby rotated relative to the first to third output-side plates 113, 114 and 115. Because of this, a force inputted to the input-side rotary part 110 from the output-side rotary part 111 can be reduced, whereby the input-side rotary part 110 can be made compact. In other words, the damper device 101 can be made compact.

<Modification>

An embodiment herein described is a modification of the second embodiment. The second embodiment has exemplified the configuration that the output-side rotary part 111 includes the first to third output-side plates 113, 114 and 115.

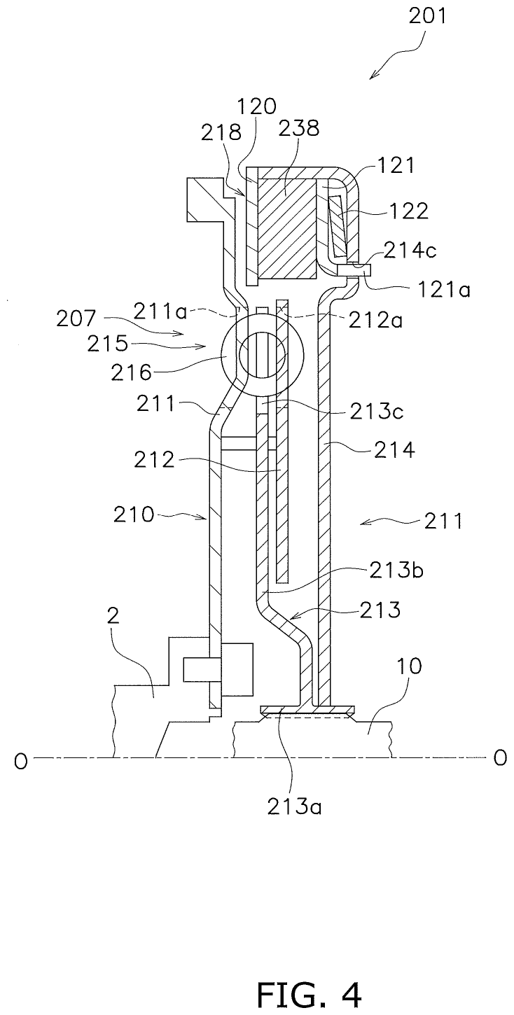

In this modification, as shown in FIG. 4, in a damper device 201, an input-side rotary part 210 includes first and second input-side plates 211 and 212, whereas an output-side rotary part 211 includes fourth and fifth output-side plates 213 and 214.

In this case, the first and second input-side plates 211 and 212 are configured to be unitarily rotatable with each other. The first and second input-side plates 211 and 212 are provided with a plurality of pairs of window portions 211a and 212a. A plurality of fourth torsion springs 216 in a damper part 215 are disposed in the plural pairs of window portions 211a and 212a, respectively.

The fourth output-side plate 213 includes a boss portion 213a and a plate body 213b. The boss portion 213a is attached to the transmission-side member 10 by coupling means such as spline coupling, while being unitarily rotatable therewith. The plate body 213b extends radially outward from the outer peripheral surface of the boss portion 213a. A plurality of fourth transmission portions 213c are provided in the outer peripheral part of the plate body 213b, while being aligned at intervals in the circumferential direction. Each of the plural fourth torsion springs 216 is disposed between circumferentially adjacent two of the plural fourth transmission portions 213c.

The fifth output-side plate 214 is configured substantially the same as the plate body 115b of the third output-side plate 115 in the aforementioned second embodiment. Additionally, an inertia part 238 (exemplary second rotor), a holding structure 218 (exemplary holding part) and a stopper structure 207 are configured substantially the same as corresponding ones in the aforementioned second embodiment. Because of this, explanation of these components will be herein omitted, and reference signs assigned thereto are the same as those assigned to the corresponding ones in the aforementioned second embodiment.

Wan Even in the configuration of the damper device 201 herein described, when the relative rotational angle α of the fourth and fifth output-side plates 213 and 214 with respect to the input-side rotary part 210 is greater than or equal to the predetermined relative rotational angle α1 (when the stopper structure 207 has been actuated), the inertia part 238 is released from being held by the holding structure 218, and is thereby rotated relative to the fourth and fifth output-side plates 213 and 214. Because of this, a force inputted to the input-side rotary part 210 from the output-side rotary part 211 can be reduced, whereby the input-side rotary part 210 can be made compact. In other words, the damper device 201 can be made compact.

### OTHER EMBODIMENTS

The present disclosure is not limited to the embodiments described above, and a variety of changes and modifications can be made without departing from the scope of the present disclosure.

(A) In the first embodiment and the second embodiment (including the modification), the configuration of the present disclosure has been explained with use of the flywheel assembly 1 and the damper devices 101 and 201. The configuration of the present disclosure is not limited to that of the first embodiment and that of the second embodiment (including the modification), and is applicable to any device configuration as long as a power transmission device is intended as an application target of the present disclosure.

(B) In the first embodiment and the second embodiment (including the modification), the configuration of the present disclosure has been explained with use of the flywheel assembly 1 and the damper devices 101 and 201. The basic configurations of the flywheel assembly 1 and the damper devices 101 and 201 are not limited to those in the first embodiment and the second embodiment (including the modification), and can be arbitrarily set without departing from the scope of the present disclosure.

(C) The first embodiment has exemplified that the stopper structure 7 is realized by the contact of the spring seats 43. Instead of this, the stopper structure 7 can be realized by the full compression of the first torsion springs 42.

(D) The second embodiment (including the modification) has exemplified that the stopper structure 107, 207 is realized by the full compression of the third torsion springs 119. Instead of this, spring seats can be disposed on the both ends of each third torsion spring 119, and the stopper structure 107, 207 can be realized by the contact of the spring seats.

(E) The first and second embodiments (including the modification and other embodiments) have exemplified that the stopper structure 7, 107, 207 is composed of the spring seats 43 or the torsion springs 42, 118, 216. However, the components of the stopper structure 7, 107, 207 can be arbitrarily set as long as relative rotation between the input-side rotary part 4, 110, 210 and the output-side rotary part 5, 111, 211 can be restricted by the stopper structure 7, 107 and 207.

For example, the stopper structure 7 can be composed of one or more protruding portions and one or more elongated holes. The one or more protruding portions are provided in one of the input-side rotary part 4, 110, 210 and the output-side rotary part 5, 111, 211, whereas the one or more elongated holes are provided in the other of the input-side rotary part 4, 110, 210 and the output-side rotary part 5, 111, 211. In this case, each protruding portion is disposed in each elongated hole extending in the circumferential direction, and the stopper structure 7 is actuated when each protruding portion makes contact with one of the circumferential ends of each elongated hole.

### REFERENCE SIGNS LIST

1 Flywheel assembly
4 First flywheel
5 Second flywheel
6 Damper structure
7 Stopper structure
8 Holding structure
37 Second flywheel body
38 Inertia part
α1 Predetermined relative rotational angle

1. A power transmission device comprising:
an input-side rotary part to which a torque is inputted from an engine;
an output-side rotary part including a first rotor and a second rotor, the first rotor configured to be rotatable relative to the input-side rotary part, the first rotor configured to be rotatable unitarily with the input-side rotary part at greater than or equal to a predetermined relative rotational angle, the second rotor configured to be rotatable unitarily with the first rotor, the second rotor configured to be rotatable relative to the first rotor at greater than or equal to the predetermined relative rotational angle; and
a damper part configured to elastically couple the input-side rotary part and the output-side rotary part.

2. The power transmission device according to claim 1, further comprising:
a stopper structure configured to restrict the input-side rotary part and the first rotor from rotating relative to each other at greater than or equal to the predetermined relative rotational angle.

3. The power transmission device according to claim 1, further comprising:
a holding part configured to hold the first rotor and the second rotor so as to make the first rotor and the second rotor rotatable unitarily with each other at less than the predetermined relative rotational angle.

4. The power transmission device according to claim 3, wherein
the holding part is further configured to release holding of the first rotor and the second rotor at greater than or equal to the predetermined relative rotational angle.

5. The power transmission device according to claim 3, wherein
the second rotor is provided on the first rotor through the holding part.

6. The power transmission device according to claim 1, wherein
the second rotor is rotated relative to the first rotor in a rotational direction of the first rotor at greater than or equal to the predetermined relative rotational angle.

7. The power transmission device according to claim 1, wherein
the damper part is further configured to elastically couple the input-side rotary part and the first rotor.
